(19) United States
(12) Patent Application Publication
(10) Pub. No.: US 2009/0198479 A1
(43) Pub. Date: Aug. 6, 2009

(54) METHODS TO DESIGN PROBES AND PRIMERS

(76) Inventors: Lee A. BULLA, JR., Pilot Point, TX (US); Jian Sun, Irving, TX (US)

Correspondence Address: MORRISON & FOERSTER LLP, 12531 HIGH BLUFF DRIVE, SUITE 100, SAN DIEGO, CA, 92130-2040, US

(21) Appl. No.: 12/180,464

(22) Filed: Jul. 25, 2008

Related U.S. Application Data
(60) Provisional application No. 60/952,507, filed on Jul. 27, 2007.

(51) Int. Cl. G06G 7/48; G06F 3/048; G06F 17/00

(52) U.S. Cl. 703/11; 715/771

(57) ABSTRACT

A web-based computational system and method for high-throughput gene mining and target identification and validation based on conserved functional blocks automates the generation of conserved regions of high sequence similarity using algorithms and optimizes probe design for fragment amplification from homologous genomes.

### CROSS-REFERENCE TO RELATED APPLICATIONS

This application claims benefit of provisional application U.S. Ser. No. 60/952,507 filed 27 Jul. 2007. The contents of this document are incorporated herein by reference.

### TECHNICAL FIELD

The present invention relates to bioinformatics. More particularly, the invention relates to a high-throughput methods to design probes and primers for interaction with desired targets.

### BACKGROUND ART

Bioinformatics relies on algorithms, computational and statistical techniques to search bioinformation databases, analyze those results, and make useful predictions or identifications. These methods are particularly useful in the analysis of gene and protein databases. For example, the sequence of an unknown gene often exhibits structural and functional homology with a known gene. Thus, if one discovers a new gene but does not know its function, a sequence alignment can be performed with the already determined sequences and often provide information about the activity of the gene or its product.

Many industries can benefit from information obtained from a relevant bioinformatics analysis. For example, there is an increasing demand within the pesticide industry for high-throughput computational approaches for identification, characterization and validation of genes and proteins that can serve as insecticide targets. Current methodology involves a series of single-function software tools that require manual adjustment of numerous parameters during data processing. While this methodology provides useful information, robust insecticide development requires automated computational systems and analytical tools that enable target identification and validation at greater speed, more accuracy, higher capacity and specificity than is currently available.

PCT publication WO01/31011, assigned to the same assignee, discloses a system for designing primers to obtain genes encoding proteins that confer desired phenotypic effects. The invention described in this publication is also the subject of U.S. Pat. Nos. 7,349,811 and 6,928,368, both incorporated herein by reference. In the method disclosed, the starting point is a nucleotide sequence known to encode a protein that results in a phenotypic characteristic in one species, and either comparing this sequence to a nucleic acid database and extracting sequences with the greatest similarity or translating the original nucleotide sequence into an amino acid sequence and performing the matching function against a protein database. Conserved portions of the retrieved sequences are then used to design primers for retrieval of a desired gene in a different organism.

According to the method of the present invention, retrieval of the conserved regions is based on predefined parameters which are adjusted during the auto-run based on a conditional judgment algorithm until optimal results are achieved. The predefined parameters are % identity, % positives and % delta length. In one embodiment, the conserved regions are obtained from preselected portions of the protein that are critical for its function.

### DISCLOSURE OF THE INVENTION

A web-based computational pipeline (SPADE™) for high-throughput gene mining and target validation described in U.S. Pat. No. 7,349,811 is modified and improved to accommodate the algorithms involved in the present system. This improved SPADE™ method as disclosed herein enhances gene mining based on conserved functional blocks by integrating publicly available software tools, automates the generation of conserved regions of high sequence similarity using newly developed algorithms and optimizes probe design for fragment amplification from homologous genomes using proprietary computational programs. This improved SPADE™ is a highly efficient system for identifying potentially useful genes in unknown (unsequenced) genomes in the same or different organism as that of a referent known protein. Its chief advantages include speed (few seconds required per sequence), simplicity, specificity, stringency and reliability. No other computer software program provides the capability of analyzing a vast array of complex genomic and molecular data that can be utilized for high throughput gene screening and functional analysis.

In one aspect, the present invention is directed to a method for designing gene-specific probes or primers to identify and acquire a sequence encoding a desired protein, which method comprises the following steps:

selecting an amino acid sequence of a protein that confers a desired phenotype characteristic or function;

selecting one or more databases containing cataloged amino acid sequences;

extracting a plurality of cataloged protein sequences that contain at least a portion of said amino acid sequence;

prioritizing and filtering at least some of the sequences from the cataloged protein sequences that have said selected portion; and

designing one or more degenerate probes or primers to target the selected, prioritized protein sequences.

Such probes or primers can then be used to retrieve and isolate the genetic material and produce the identified proteins.

The prioritizing and filtering step comprises establishing predefined parameter initialization with graphical user interface (GUI) input; prioritizing, filtering and extracting sequences from the cataloged protein sequences; aligning the extracted cataloged sequences to the selected protein sequence; retrieval of the conserved portions based on predefined primer selection constraints, wherein said parameters are adjusted based on a conditional judgment algorithm until optimized results are achieved. The parameters used in the selection process are identities, positives, and delta length.

While the foregoing set of steps has been described starting with a protein of known amino acid sequence and comparing the amino acid sequence to those in databases that classify proteins, it is evident that a similar approach is useable starting with a nucleotide sequence that encodes a protein that confers a desired phenotype characteristic, searching nucleic acid databases for a multiplicity of matching sequences and using the computational tools of the present invention to identify conserved regions best suited for the design of primers.

### BRIEF DESCRIPTION OF THE DRAWINGS

FIG. 1 shows a schematic chart showing a gene sequence identification program in accordance with the present invention.

FIG. 2 shows an automated parameter optimization using an algorithmic approach for sorting and filtering sequences for multiple sequence alignments and selection of conserved sequence block retrieval (detailed steps of block 7).

FIG. 3 shows the distribution of Anopheles gambiae str. PEST homologs based on comparison to Drosophila melanogaster and Homo sapiens. TaxPlot (NCBI software tool) was used for the three-way genome comparison.

### MODES OF CARRYING OUT THE INVENTION

The methods of the invention are described with reference to the accompanying drawings, in which illustrative embodiments of the invention are shown. These methods may, however, be embodied in many different forms and should not be construed as limited to the embodiments set forth herein. The specific embodiments discussed herein are merely illustrative of specific ways to make and use the invention and do not delimit its scope.

Unless defined otherwise, all technical and scientific terms used herein have the meanings commonly understood by one of ordinary skill in the art to which this invention belongs.

As used herein, “a” or “an” means “at least one” or “one or more.”

The practice of the present invention will employ, unless otherwise indicated, conventional techniques of molecular biology (including recombinant techniques), which are within the skill of the art. Such techniques are explained fully in the literature, such as, MOLECULAR CLONING: A LABORATORY MANUAL 3rd ed. (Sambrook et al. (eds.), Cold Spring Harbor Press 2001); OLIGONUCLEOTIDE SYNTHESIS: METHODS AND APPLICATIONS (Herdewijn, P. (ed.), Humana Press 2004); CURRENT PROTOCOLS IN MOLECULAR BIOLOGY (F. M. Ausubel et al. (eds.), Wiley Interscience most current edition); PCR PROTOCOLS: A GUIDE TO METHODS AND APPLICATIONS (Innis et al. (eds.), Academic Press 1989); SHORT PROTOCOLS IN MOLECULAR BIOLOGY (Ausubel, et al. (eds.), Wiley and Sons, 2002), CLONING, GENE EXPRESSION, AND PROTEIN PURIFICATION: EXPERIMENTAL PROCEDURES AND PROCESS RATIONALE (Hardin et al. (eds.), Oxford University Press 2001); and DNA CLONING 3: A PRACTICAL APPROACH (Glover, D. M. (ed.), Elsevier Academic Press 1995).

Provided herein is an improved web-based computational pipeline (SPADE™) for high-throughput gene mining and target identification using automated sequence homology analysis and data management. Embodiments of the pipeline system can (i) enhance gene mining based on conserved functional blocks, (ii) automate the generation of conserved regions of high sequence similarity using newly developed algorithms and (iii) optimize the design of probes or primers shared among homologous genomes. The methods of the invention result in the design of probes or primers which permit the retrieval and/or amplification of desired nucleotide sequences. Probes can be specific or degenerate. Nucleic acid molecules that are useful as probes or primers are usually less than 100 nucleotides in length. Often a nucleic acid primer or probe is from about 50 nucleotides in length to about 10 nucleotides in length. In some embodiments, the primers or probes can be used for fragment-amplification from various genomes in a PCR reaction or used to screen cDNA libraries.

The mechanics of system operation are simple and straightforward. First, at least one sequence with interesting functional/phenotypic characteristics from a known species is selected for input into the system. Either amino acid sequences or nucleotide sequences can be used as the starting point. Then, the system carries out a sequence similarity search for each target sequence against the appropriate databases to quickly identify possible homologous sequences among all known species. A set of sequences is derived through automated optimization of various parameters to align multiple sequences. The system uses the sequence alignments to retrieve conserved fragments. After a series of analyses and verification steps, optimal primer pairs selected from these fragments are designed for PCR amplification to identify and clone the target genes from an unknown genome or to design probes. The target genes can be used for instance to develop and implement target-based chemical screens to identify small molecular modulators of specific gene products. In one embodiment, the software program can be written in Perl/CGI and VB and can be run on Windows platform. The program is very efficient, taking only a few seconds per sequence on a typical workstation, rendering it highly efficient in identifying potential targets and suitable for high throughput gene target screening. This newly developed system also provides an effective approach for identification and cloning of targeted functional genes from unknown genomes.

Sequences with interesting functional/phenotypic characteristics from known species are first selected through data mining of available biological databases. In one approach, the targeted species are considered orthologous to the known species. For each input target sequence, a local standalone search program such as BLAST can be utilized to search against protein or nucleic acid databases to quickly identify possible homologous sequences in all known species.

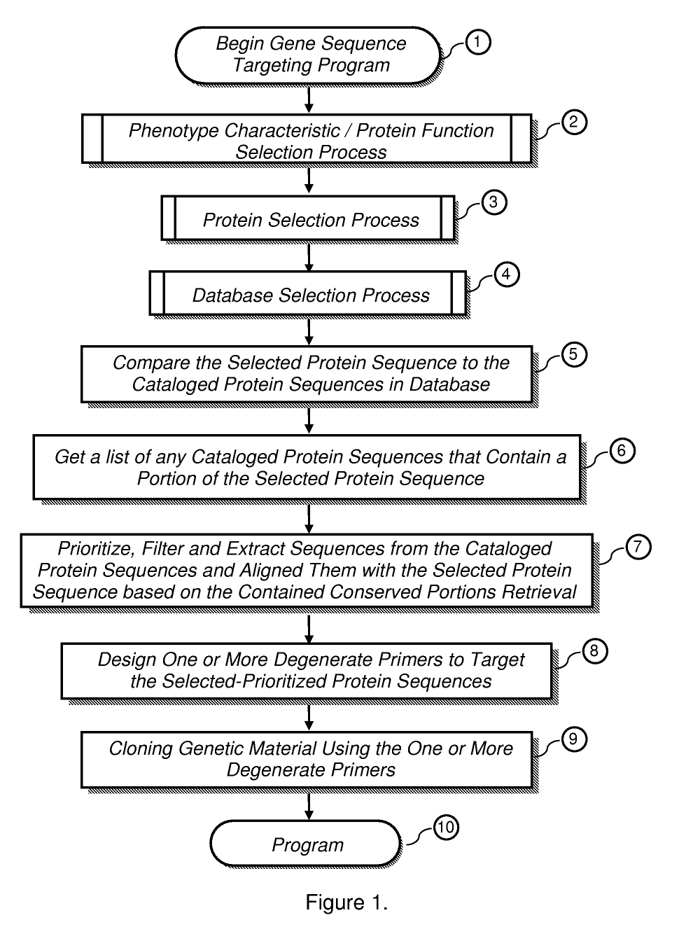

FIG. 1 shows a basic flowchart of an illustrative gene sequence targeting program in the newly developed improved SPADE™ system based on a protein referent and employing protein databases. The gene sequence program begins with a selection of the desired phenotype characteristic or protein function (block (2)). Once the phenotype characteristic or protein function is selected, then the protein or fragment thereof is selected (block (3)). The database containing cataloged protein sequences to be searched is then selected (block (4)). Selected protein sequences are compared to the cataloged protein sequences in block (5) and a list of cataloged protein sequences, containing a portion(s) of the selected protein sequence, is extracted in block (6). Together, these two steps can be claimed as the “sequence similarity search process,” which is complemented by utilizing a alignment program, such as a BLAST program, with pre-defined parameters set by GUI input.

After obtaining a list of cataloged protein sequences that contain a portion(s) of the selected protein sequence, additional sequence selection from the cataloged sequence list and their alignment to the selected protein sequence is necessary to extract valid, conserved segments among the aligned sequences, i.e., the conserved functional block. The conserved segments thus retrieved will be utilized for primer or probe design to target the selected sequences. An automated computer process has been developed for extracting prioritized and filtered protein sequences and for selecting conserved portions, based on alignment of the extracted protein sequences, with the selected protein sequence in block (7). It is a cyclic, automatic process that utilizes the software program to gradually adjust the parameters until optimized results are achieved.

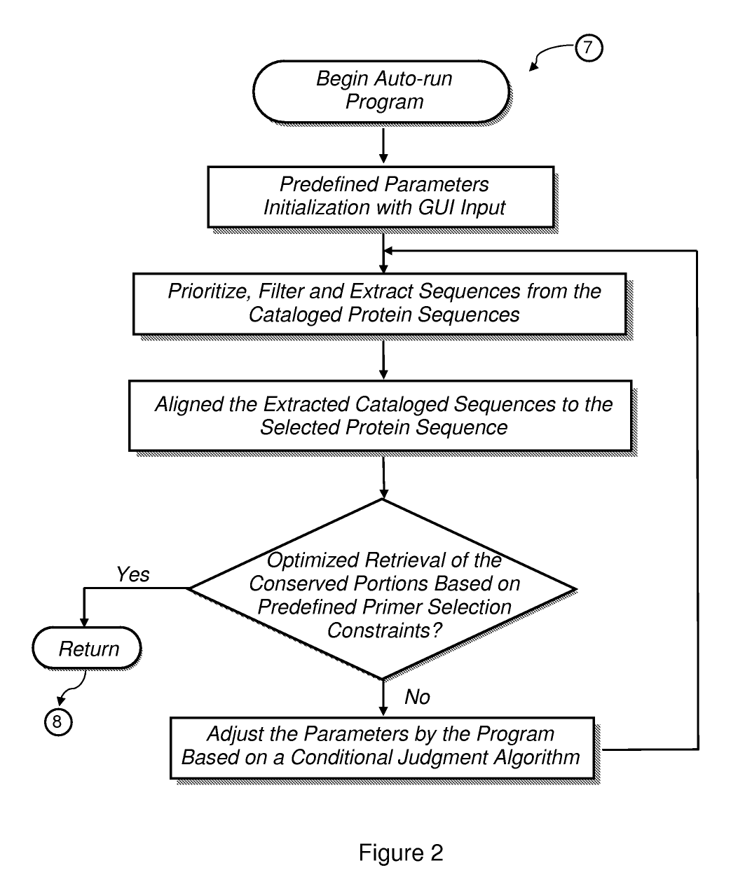

More particularly, once similarity search results are obtained, instead of manually selecting sequences for multiple sequence alignments, an automated parameter optimization algorithmic approach is developed and used to sort and filter homologous sequences from the search results, as exemplified in FIG. 2. Three primary parameters are used for sorting and filtering sequences from the search results: minimum identity (%) [0-100]; minimum positives (%) [0-100]; and delta length (%) [0-100]. Then, multiple sequence alignment analysis is conducted with the selected sequences, and conserved sequence blocks (gene-specific fragments) are retrieved from the alignment results based on several constraint parameters, which include (i) conservation similarity (%), (ii) conserved block length and (iii) distances between blocks. Reverse translated sequences of these fragments are used to further design any potential forward and reverse primer sequences or to design probes.

FIG. 2 shows the detailed steps of this automatic (“Auto-run”) program that prioritizes, filters and extracts the sequences as detailed in block (7) of FIG. 1. In this program, three primary parameters are predefined and set to a default value. These initial values are input by the user through the system GUI and are used by the software program for filtering and extracting sequences from the list of cataloged protein sequences. The extracted protein sequences are aligned to the selected protein sequences to determine whether there are valid, conserved portion pairs available among the contained sequences for primer design. All conserved portions are retrieved based on evaluation of the parameters and constraints of primer design.

In the next step, one or more degenerate probes or primers are designed (based on valid, conserved portions among the aligned sequences), to target the selected gene sequences in block (8) of FIG. 1, and genetic material is cloned using the one or more degenerate probes or primers in block (9). The program is complete in block (10).

The initial selection criterion is selecting a phenotype characteristic or a function of the desired protein. Functions and characteristics can be those associated with cellular signaling, enzyme activity, adhesion, protein, cellular, tissue or organ structure; locomotion, intracellular or extracellular transport, chemosensitivity, toxin sensitivity, toxin resistance, metabolic processes, cell division, DNA repair, DNA replication, mRNA synthesis, antigenicity, membrane transport and/or permeability, endocytosis, exocytosis, and the like.

The amino acid sequence(s) or their encoding nucleotide sequences selected that have the desired phenotype characteristic or function can be derived from known species of organism. Such organisms include mammals, bacteria, virus, insects, and plants. The amino acid sequence or nucleotide sequence selected can represent an entire protein, a fragment of the protein, or even a single specific domain of the protein that contributes to, causes, or is critical for the desired phenotype characteristic or function.

As set forth above, instead as using as a starting point amino acid sequences that have the desired phenotype, gene sequences encoding these amino acid sequences can be used. The programs differ only in that nucleic acid databases are employed rather than protein databases.

In one embodiment, the selected function or phenotype associated with one or more known proteins that is suitable as an insecticide target may be employed. Desirable insecticide targets can be ones that reduce or otherwise limit lifespan or reproduction of the targeted species. In some cases, the function or phenotype may be one that affects multiple species. Such insecticide targets can include but are not limited to ion channels, receptors, enzymes, and inhibitors of lipid and/or protein metabolism.

Any suitable protein database may be employed with the disclosed methods. Exemplary databases can include, but are not limited to SwissProt, TrEMBL, DDBJ, DAtA, nr (NCBI non-redundant), OWL, PIR, ProDom, and the like. Libraries of unknown or uncharacterized protein sequences can also be obtained from the amino acid sequences encoded within isolated genomic or cDNA libraries. Proprietary databases of nucleotide or polypeptide sequence may also be used. In one embodiment, the subject amino acid molecules, or fragments or derivatives thereof, may be obtained from an appropriate cDNA library prepared from any suitable insect species. Exemplary libraries can include, but not limited to those obtained from D. melanogaster, Anopheles gambiae, Culex pipiens and Aedes aegypti.

Similarly, appropriate databases that disclose nucleotide sequences include nt NCBI (NCBI nucleotide database), EMBL-Bank (EMBL nucleotide database).

When a desired phenotype characteristic or function is identified, it is compared to amino acid sequences that are considered related to one or more known reference amino acid sequences that express the desired phenotype characteristic or function. The relatedness of the unknown or uncharacterized sequences can be at the level of general activity (e.g., protein kinase activity), species relatedness or the database of sequences analyzed can be completely unrelated and/or uncharacterized. In one embodiment, the reference amino acid sequence is from a species of organism whose genome is sufficiently characterized to know that the reference protein has the desired characteristic or function. This reference protein can then be compared to amino acid sequences from a newly isolated, though uncharacterized genome of a related species. In some embodiments, the species is an orthologous species. In other embodiments, the reference amino acid sequence is not from a related species. In some embodiments, a useful protein sequence can be rapidly identified in a newly identified organism, facilitating rapid identification of key targets for development of new modulators of that sequence's activity and/or expression. Nucleotide sequences encoding the selected amino acid sequence may also be used.

Sequences are extracted from the database for analysis through alignment of the sequences to identify similar or homologous sequences. The methods can employ any suitable sequence similarity searching tool. For example, BLAST, FASTA, or EMBOSS are useful. See Altschul, J. Mol. Biol. 215:403-10 (1990); Lipman and Pearson, Science 227:1435-41 (1985); Pearson and Lipman, Proc. Nat'l Acad. Sci. U.S.A. 85:2444-48 (1988); Smith and Waterman, Adv. Applied Math. 2:482-89 (1981). BLAST searches can include WU BLAST, NetBLAST, blastn, blastp, PSI-BLAST, blastx, tblastx, tblastn, and megablast searches. FASTA searches can include FASTX, TFASTA, TFASTX, and FASTA searches.

Any suitable operating system may be employed with the claimed methods. Such operating systems include MS-Windows, MAC, Linux, and UNIX.

Prioritization, filtering and extracting at least some of the sequences from the catalogues protein sequences having the selected phenotypic characteristic or function employs predefined parameters initially established with GUI input. In one embodiment, three primary parameters can be used for sorting and filtering sequences from the cataloged protein sequence search results: identity, positives, and delta length.

Prioritized sequences from the cataloged sequences are then selected for sequence comparison analysis to extract the valid conserved portions among all these aligned sequences. The methods can employ any suitable sequence alignment comparison tools. For example, ClustalW, BlastAlign and T-COFFEE are useful. See Chenna, Nucleic Acids Res. 31(13):3497-500 (2003); Belshaw, Bioinformatics, 21:122-123 (2005) Notredame, J. Mol. Bio., 302:205-217 (2000).

Minimum identity requires a specified percentage of residue matches (i.e., is identical) or shares identity with each query. The identity can range from 0-100%. In some embodiments, the identity ranges from 20-80%. This parameter filters or eliminates subject sequences of less than the specified percent identity (residue matches) with each query.

Minimum positives requires that a specified percentage of residues match (are identical) or are conservative substitutions. The minimum positives can range from 0-100%. In some embodiments, the minimum positives range from 20-90%. The parameter filters or eliminates subject sequences of less than the specified percent positives (residue matches plus conservative replacements) with each query.

Minimum delta length requires that the subject sequences be a specified percentage less than or greater than the query sequence length. The delta length can range from 0-100%. The delta length filters or eliminates subject sequences that are less or greater than a proportion of the query sequence length.

While minimums are initially selected or predefined for each of the parameters, the parameters are adjusted during the selection process to identify conserved regions that are valid for primer or probe design using the conditional judgment algorithm. In one embodiment, the algorithm is the multiple sequences alignment theory.

Any suitable method for designing one or more specific or degenerate probes or primers to target the selected, prioritized protein sequences may be employed. In one embodiment, Several Perl and VB scripts were developed for primer pair testing, optimization and verification. A script was constructed to perform BLAST searches to verify primer specificity. It is noteworthy that two conserved domains in the alignment of amino acid sequences do not ensure a conserved domain in the corresponding DNA sequences. Therefore, reverse translations of selected probe pairs can be submitted to, for example, a Blastn search in the NCBI databases to ascertain any potential mismatch sites. Any suitable search program can be employed for these aspects of the analysis. If no such hits are found, an alternative gene-specific fragment is required to design potential new probes or primers. This particular process is continued until suitable probes or primers are discovered.

Any further primer design or optimization is achieved by adjusting and trimming potential primer sequences based on a variety of parameters, including primer size, melting temperature, GC content, GC clamp and self complementarity, among others. Additional software can then used to retrieve primer pair sequences from the preceding tasks and to subject them to PCR amplification using appropriately selected probes or primers. Such software includes, but is not limited to Fast PCR©, Primer3, Beacon Designer, Premier Primer, AlleleID, SYBR® Green probes or primers.

For embodiments based on amino acid sequence, degenerate primers are designed by reverse translating conserved blocks of residues using their respective genomic codons and codon usages of the aligned organisms. The IUPAC symbols are adopted for degeneracy. The degeneracy can be reduced in any suitable manner including shortening the primer from either end, eliminating codons with high degeneracy, or using the most codon based on codon usage of the aligned organism. In one example, probe or primer design is simplified to bi-degeneracy because only the corresponding genomic codons from both the known and the target species, based on codon usage and two-fold IUPAC symbols for degeneracy, are considered. Thus, newly customized degenerate probes or primers can be made available to successfully amplify homologous gene fragments from any two specified organisms.

Exemplary Uses in Research and Drug Discovery Programs

The methods provided herein are particularly useful in mining for sequences encoding proteins or fragments thereof with a defined function or phenotypic characteristic. In such applications of the methods, a protein sequence or any biologically relevant portion thereof can be used as the initial selection criterion. Such a sequence can define a phenotypic characteristic or function or be associated with such a characteristic or function. The sequence can be one or more unique binding sequences or signalling motifs associated with or defining a phenotypic characteristic or function, a sequence that encodes one or more functional protein domains associated with or defining a phenotypic characteristic or function, or an entire protein. The phenotypic characteristic or function can be one that positively correlated with protein expression (e.g., if the protein or biologically relevant portion is present, then the phenotypic characteristic or function is present) or inversely correlated (e.g., if the protein or biologically relevant portion is absent, then the phenotypic characteristic or function is present). Functions and characteristics can be those associated with cellular signaling, enzyme activity, cellular adhesion; cancer metastasis; angiogenesis and neoangiogensis; nuclear transport; protein, cellular, tissue or organ structure; locomotion; intracellular or extracellular transport; chemosensitivity; toxin sensitivity or resistance; radiosensitivity; radioresistance; metabolic processes; meiosis; cell division or replication; DNA repair; DNA replication; mRNA synthesis, RNA processing; protein processing and folding; antigen processing and antigenicity, membrane transport and/or permeability; pathogen sensitivity or resistance; endocytosis; exocytosis; and the like.

In some embodiments, the methods provided herein permit rapid, accurate identification of proteins or biologically relevant protein or nucleotide sequences from newly isolated genomes that have no or limited characterization. This is particularly useful for infectious disease and pathogen management. For example, the methods provided herein make possible the identification of a particular protein or biologically relevant protein sequence in a newly identified organism (e.g., virus, bacteria or fungi) where the genome is isolated but not yet fully characterized. The ability to rapidly determine the presence (or absence) of such a protein or biologically relevant protein sequence may provide guidance in the treatment and/or handling of a population exposed or at risk of exposure to this new infectious organism or pathogen.

Such methods provide for rapid identification of useful targets in drug discovery programs. One recurring barrier to efficient application of information obtained in drug discovery programs. For example, the identification of a particular protein or biologically relevant protein sequence that confers sensitivity to a particular chemotherapeutic agent in a specific tumor type likely does not provide any information regarding the relative expression of the protein throughout a particular patient population having the specific tumor, but for example, receiving different treatment regiments, nor any information on whether such a protein or biologically relevant protein sequence is present in other tumor types, whether related or not. The methods provided herein facilitate rapid screening of libraries of protein sequences from such tumors in one example. Libraries of protein sequence can be those from patient populations with related disease profiles, disease susceptibility profiles, and the like.

While such constraints limit typical drug screening protocols in human populations, the same, but often greater limitations constrain application of relevant drug targeting information in non-human animal, plant, and insect populations. The methods provided herein permit libraries of protein sequences to be rapidly screening to identify relevant protein sequences associated with one or more drug targets or mechanisms of action.

The following examples are offered to illustrate but not to limit the invention.

### Example 1

Algorithmic Approach for Selection of Conserved Sequence Block Retrieval

Exemplary periodical results generated by the algorithmic approach disclosed herewith is shown in Table 1. The methodology described is much more efficient than other conserved blocks finder techniques, e.g., BLOCKS maker, in that (i) it provides an automated approach for optimizing the retrieval of all possible highly conserved regions among sequence alignments inspected and (ii) it compensates for experimental constraints that otherwise would interfere with primer pair design.

Based on the three initialization values in Table 1 (Identities=30%, Positives=30%, Delta Length=30%), Cycle 1 extracted 15 cataloged sequences and aligned them to the selected protein sequence. Two conserved portions were obtained but neither one was valid for primer design (Table 1, Row 3, Columns 6-8). Consequently, the three primary parameters must be adjusted by the software program based on our conditional judgment algorithm. In another words, the parameters are adjusted according to a multiple sequences alignment theory, i.e., the more sequences involved in the alignment, the fewer conserved portions retrieved, and vice versa. The adjusted parameters are then used for the next cycle to extract a different number of cataloged protein sequences and to align them again to the selected protein sequence. This exercise will reveal whether valid conserved portion pairs can be retrieved. The cycle is repeated until optimized results are achieved. For example, after 20 cycles (Table 1, Sequence 1) with the parameters adjusted to Identities=34%, Positives=34% and Delta Length=45%, the optimized output result are: 7 extracted cataloged sequences, 9 conserved portions and 5 valid portion pairs for primer design (Table 1, Row 8, Columns 6-8).

TABLE 1
Periodical results generated by the Auto-run program

| | | Input Parameters | | | Output | | |
|---|---|---|---|---|---|---|---|
| Blast | Auto | Identities | Positives | Delta Length | Alignment | Retrieved | Potential Primer |
| Results | run | (%) | (%) | (%) | Sequences | Blocks | Pairs |
| Sequence 1 | Cycle 1 | 30 | 30 | 30 | 15 | 2 | 0 |
| | Cycle 2 | 31 | 31 | 30 | 7 | 3 | 2 |
| | Cycle 3 | 32 | 32 | 30 | 6 | 36 | 218 |
| | Cycle 17 | 32 | 32 | 44 | 7 | 3 | 1 |
| | Cycle 19 | 34 | 34 | 44 | 6 | 36 | 218 |
| | Cycle 20 | 34 | 34 | 45 | 7 | 9 | 6 |
| Sequence 2 | Cycle 1 | 30 | 30 | 30 | 34 | 0 | 0 |
| | Cycle 2 | 31 | 31 | 30 | 24 | 0 | 0 |
| | Cycle 4 | 33 | 33 | 30 | 16 | 3 | 1 |
| | Cycle 8 | 37 | 37 | 30 | 15 | 6 | 3 |
| Sequence 3 | Cycle 1 | 30 | 30 | 30 | 3 | 56 | 421 |
| | Cycle 2 | 30 | 30 | 31 | 3 | 56 | 421 |
| | Cycle 3 | 30 | 30 | 35 | 4 | 10 | 2 |
| Sequence 4 | Cycle 1 | 30 | 30 | 30 | 3 | 34 | 142 |
| | Cycle 17 | 30 | 30 | 33 | 4 | 29 | 127 |
| | Cycle 18 | 30 | 30 | 47 | 5 | 18 | 41 |
| | Cycle 29 | 30 | 30 | 59 | 12 | 8 | 7 |

### Example 2

### Identification and Validation of Genes in Anopheles gambiae

The pipeline system SPADE™, implemented in Perl/CGI and several VB and Perl scripts, employed a BioPerl-based executable file, which ran as a typical CGI script on an Apache web server. Running the system required a standard Perl 5.8.7 installation, a few Comprehensive Perl Archive Network (CPAN) Perl modules, the BioPerl 1.4 set of modules and formatting to searchable local NCBI databases. A local standalone BLAST program, using BioPerl StandAloneBlast.pm (Perl Module), was computed to search against protein databases to quickly identify possible homologous sequences in all known species. The selected cataloged sequences were aligned using BioPerl ClustalW.pm to conduct the standalone multiple sequence alignment analysis. The public database nr.fas from NCBI was downloaded locally and updated routinely to facilitate virtual searches. The system enabled the identification, validation and cloning of a variety of genes in Anopheles gambiae, which were expressed successfully in a surrogate insect cell line. Although the An. gambiae genome was decoded in April, 2002, the biological function of most An. gambiae genes remains unknown. Therefore, to help identify and validate functionality of the genes cloned from An. gambiae and to ascertain their potential as insecticide targets, Drosophila melanogaster, whose genome has been analyzed extensively, was utilized as a comparative organism for homology analysis.

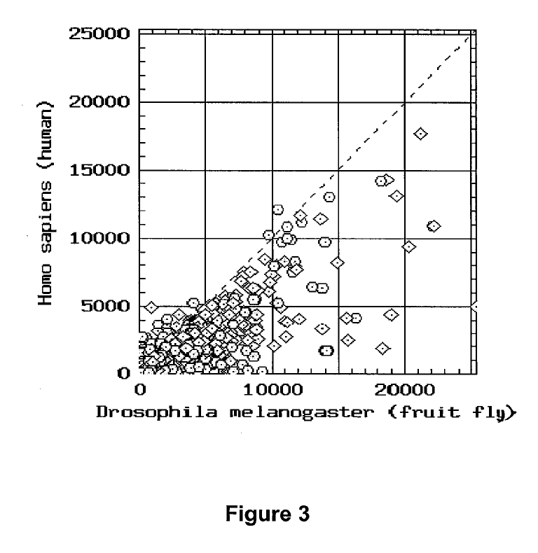

One hundred thirty eight transmembrane proteins, most of which are receptor proteins and whose functionality has been established in D. melanogaster, were selected for input into SPADE™. FIG. 3 shows the distribution of An. gambiae str. PEST homologs in D. melanogaster as well as in Homo sapiens. Ninety-five genes were identified and cloned from an An. gambiae cDNA library using optimal primer pairs. Single, specific and strong amplification products ultimately were generated for the 95 genes, all of which can be used for chemical screening of synthetically derived organic compounds and natural products. The results of PCR amplification indicate that SPADE™ is efficient and reliable for designing specific probes for high throughout gene/protein identification and screening. Multiple sets of the 95 expressed proteins now are available for rapid and simultaneous validation as potential insecticide targets for An. gambiae and other mosquito species.

Experiments were also performed using Culex pipens and Aedes aegypti with similar results.

1. A method for designing probes or primers to identify a nucleotide sequence encoding a desired protein, which method comprises the steps of:
providing an amino acid sequence of a protein associated with a desired phenotype characteristic or protein function;
selecting one or more databases containing cataloged amino acid sequences;
extracting a multiplicity of cataloged amino acid sequences that contain at least a portion of said first amino acid sequence;
prioritizing and filtering at least some of the extracted sequences from the cataloged protein sequences having said portion of protein of said first amino acid sequence; and
designing one or more degenerate probes or primers to identify a nucleotide sequence encoding a desired protein,
wherein said prioritizing or filtering step comprises
establishing predefined parameter initialization with graphical user interface (GUI) input;
aligning the extracted cataloged sequences to the first amino acid sequence;
retrieving the conserved portions based on predefined parameters, wherein said parameters are adjusted based on a conditional judgment algorithm until optimized results are achieved, wherein said predefined parameters are % identity, % positives, and % delta length.

2. The method of claim 1 wherein said portion is a functional region of the protein.

3. The method of claim 1, further comprising a step of cloning said nucleotide sequence using the one or more designed primers.

4. The method of claim 1, wherein the one or more databases are selected from databases comprising cataloged amino acid sequences for humans, rats, mice, zebra fish, frogs, Drosophila, nematode, C. elegans, mosquito and bacteria.

5. A system for designing primers or probes which primers or probes target a nucleotide sequence wherein the expression of said nucleotide sequence results in at least one phenotypic characteristic comprising:
one or more computers collectively having program means thereon for performing the method of claim 1; and
one or more databases containing the cataloged amino acid sequences; and
a communication link connecting the computer or computers to said one or more databases.

6. A computer system embodied on a computer-readable medium for designing probes or primers to identify and target a nucleotide sequence wherein the expression of said nucleotide sequence results in at least one phenotypic characteristic, said computer system comprising:
means for providing a first amino acid sequence of a protein associated with a desired phenotype characteristic or protein function;
means for selecting one or more databases containing cataloged amino acid sequences;
means for extracting a multiplicity of cataloged amino acid sequences that contain at least a portion of said first amino acid sequence;
means for prioritizing and filtering at least some of the extracted sequences from the cataloged protein sequences having said portion of protein; and
means for designing one or more degenerate probes or primers to identify a nucleotide sequence encoding a desired protein,
means for displaying the sequences of said probes or primers,
wherein said prioritizing or filtering step comprises
establishing predefined parameter initialization with graphical user interface (GUI) input;
aligning the extracted cataloged sequences to the first amino acid sequence;
retrieving the conserved portions based on parameters, wherein said parameters are adjusted based on a conditional judgment algorithm until optimized results are achieved,
wherein said predefined parameters are % identity, % positives, and % delta length.

7. A method for designing probes or primers to identify a nucleotide sequence encoding a desired protein, which method comprises the steps of:
providing a first nucleotide sequence that encodes a protein associated with a desired phenotype characteristic or protein function;
selecting one or more databases containing cataloged nucleotide sequences;
extracting a multiplicity of cataloged nucleotide sequences that contain at least a portion of the first nucleotide sequence;
prioritizing and filtering at least some of the extracted sequences from the cataloged nucleotide sequence having said portion of said first nucleotide sequence; and
designing one or more probes or primers to identify a second nucleotide sequence encoding a desired protein,
wherein said prioritizing or filtering step comprises
establishing predefined parameter initialization with graphical user interface (GUI) input;
aligning the extracted cataloged sequences to the first amino acid sequence;
retrieving the conserved portions based on predefined parameters, wherein said parameters are adjusted based on a conditional judgment algorithm until optimized results are achieved,
wherein said predefined parameters are % identity, % positives, and % delta length.

8. The method of claim 7 wherein said portion encodes a functional region of the protein.

9. The method of claim 7, further comprising a step of cloning said nucleotide sequence using the one or more designed primers.

10. The method of claim 7, wherein the one or more databases are selected from databases comprising cataloged nucleotide sequences for humans, rats, mice, zebra fish, frogs, Drosophila, nematode, C. elegans, mosquito and bacteria.

11. A system for designing primers or probes which primers or probes target a nucleotide sequence wherein the expression of said nucleotide sequence results in at least one phenotypic characteristic comprising:
one or more computers collectively having program means thereon for performing the method of claim 7; and
one or more databases containing the cataloged nucleotide sequences; and
a communication link connecting the computer or computers to said one or more databases.

12. A computer system embodied on a computer-readable medium for designing primers or probes to identify and target a nucleotide sequence wherein the expression of said nucleotide sequence results in at least one phenotypic characteristic, said computer system comprising:
means for providing a first nucleotide sequence that encodes a protein associated with a desired phenotype characteristic or protein function;
means for selecting one or more databases containing cataloged nucleotide sequences;
means for extracting a multiplicity of cataloged nucleotide sequences that contain at least a portion of the first nucleotide sequence;
means for prioritizing and filtering at least some of the extracted sequences from the cataloged nucleotide sequence having said portion of said first nucleotide sequence; and
means for designing one or more probes or primers to identify a second nucleotide sequence encoding a desired protein,
and displaying the sequence of the probes or primers,
wherein said prioritizing or filtering step comprises
establishing predefined parameter initialization with graphical user interface (GUI) input;
aligning the extracted cataloged sequences to the first nucleotide sequence;
retrieving the conserved portions based on predefined parameters, wherein said parameters are adjusted based on a conditional judgment algorithm until optimized results are achieved,
wherein said predefined parameters are % identity, % positives, and % delta length.
